(19) United States
(12) Patent Application Publication
(10) Pub. No.: US 2003/0220834 A1
(43) Pub. Date: Nov. 27, 2003

(54) Retail loyalty system (RLS) with embedded web server

(76) Inventors: Brian Leung, Kowloon (CN); Wah-Cheong Hui, New Territories (CN)

Correspondence Address: ALIX YALE & RISTAS LLP, 750 MAIN STREET, SUITE 1400, HARTFORD, CT, 06103, US

(21) Appl. No.: 10/153,060

(22) Filed: May 21, 2002

(51) Int. Cl. G06F 17/60

(52) U.S. Cl. 705/14

(57) ABSTRACT

A Retail Loyalty System for retailers to create and sustain customer loyalty and repeat purchases, that is layered over the Internet, and utilizes the Smart Card technology to store the loyalty points and personal information; built-in Ethernet and TCP/IP Network Interface and built-in Embedded Web Server allow web-based administration; a network terminal allows the shoppers to check their loyalty points in real-time manner, and allows the shoppers to select the reward items to redeem on the LCD display with touch-screen panel; a POS Add-in Module to allow adding the loyalty points earned by the purchase transaction, and to allow deducting the loyalty points resulted by redeeming reward items. The reward scheme may be updated & readjusted remotely by the computer at the head office via the Internet, and may be synchronized across all the branches of the retailer. Optionally, all the transaction logs can be uploaded to a centralized CRM database server for CPM (Customer Relationship Management) purpose.

### BACKGROUND OF THE INVENTION

1. Field of the Invention

The invention relates to Internet devices for retail industry and more particularly, to such devices that enable retailers to implement low-cost loyalty program and collect shoppers' information with smart card technology.

2. Description of the Related Art

In today's highly competitive business environment in retail industry, retailers have been using different loyalty programs to create and sustain customer loyalty. These programs, such as loyalty points, coupons, and sweepstakes, have been used for many years to encourage customers to purchase.

Although the advance in technology has enabled retailers to enhance and automate many of their daily operations, however, most retailers are still using a variety of traditional low-tech approaches to implement the loyalty programs, and those traditional approaches pose many problems.

The most common implementation of the retail loyalty program today is to issue clumsy paper-based loyalty cards to the shoppers. A stamp (or sticker) is added to the card for every certain amount of money spent in the retail store. Once a shopper has accumulated a certain number of stamps (i.e. loyalty points) within a certain period of time (e.g. within 3 months), the shopper may use the loyalty card to redeem some gifts, or to get discount on the next purchase.

This approach is in general a low-cost approach. Despite this low-cost advantage, however, the paper-based loyalty card is notorious for its easily-wear-and-tear characteristic. Once it starts to wear, the shopper will no longer be willing to carry it along while shopping, and will not stick to the program anymore.

Also, it is difficult and very costly to avoid forgery stamps and stickers, The procedures of adding stamps and stickers are done manually, and it is easy for the retailer's staff to issue forgery stamps and stickers to someone's loyalty card.

Alternatively, some retailers may have used more advanced way in replacing the paper-based loyalty card with plastic magnetic swipe card. Although this approach does not suffer from the above wear-out problem, however, due to the limited memory in the magnetic card, a centralized database must be kept and maintained to record all the customers' transactions and loyalty points. These centralized databases are expensive to operate and maintain, and most small to medium sized retailers cannot afford the costs.

Another disadvantage with the limited memory in the magnetic card is that it cannot be used to store shoppers' personal information, such as name, sex, age, and the shopping habits. And again it must rely on the centralized database, which makes it difficult for the retailers to implement the Customer-Relationship Management (CRM) programs.

Both approaches discussed above usually require the shopper to spend at least a 1;5 minimum amount of money (such as $100) to get one loyalty point. Therefore, it is difficult for retailers that due mostly with small-amount transactions, such as those 24-hours convenient stores, to implement the program. It would be impractical to ask the retailer to adhere a sticker to the shopper's loyalty card for every single dollar the shopper spends.

Another drawback with these traditional approaches is the small volume of participants, It is usually difficult for retailers to recruit enough participants in store to justify the loyalty program. It is because under most cases, the shopper needs to provide much personal information, such as name, age, martial status, social insurance number, address, telephone number, and so on, before the shopper can participate the loyalty program. These inevitably engenders privacy issues, and most shoppers are reluctant to provide the information before they have enjoyed the benefits of the loyalty programs.

The reward schemes of these loyalty programs are usually preprinted on the loyalty cards, and the retailers do not have the flexibility to alter the schemes to adapt for any product specific promotion, seasonal campaign and time-sensitive promotion.

Under these traditional approaches, it is very difficult and inconvenient for shoppers to get their updated loyalty points. Often a shopper needs to call the customer hot line and ask the operator for the point balances. Alternatively, some retailers may use the web-based approach, such as allowing shoppers to get their loyalty points on their own with web browser via the Internet. This approach are also cumbersome and requires specialized knowledge to use effectively, and will alienate techno-phoebes (such as the ciderly), introduce learning curve, and engender privacy issues.

### SUMMARY OF THE INVENTION

The invention provides a flexible, interactive, low-cost, smart card-based Retail Loyalty System (RLS) solution for retailers, that is layered over the Internet. The system enables retailers to reward shoppers for their patronage and encourage repeat purchases by implementing a point-based reward system.

The system is easy for retailers to implement, and convenient for shoppers to use. The system does not require any expensive centralized database infrastructure, and does not require costly maintenance and supports. Retailers may at any time change the reward schemes among their branches to cope with the seasonal and time-sensitive promotions. Shoppers may conveniently review their loyalty points and shopping history, and interactively select the redeemable gifts, without any need to ask for assistance while they are enjoying their shopping in the stores.

The Retail Loyalty System consists of a number of network terminals in each retail store. The network terminal is preferably a wall-mounted unit with small footprint, and with a small display unit, preferably a 6.5″ LOD monitor, to display the shopper's personal information. During the idle time, the network terminal may also display advertisements and promotion materials, in short-movie or in still-picture form, through the display unit.

The retailer issues a loyalty card to each shopper who participates in the loyalty program. The loyalty card may be a contact-type smart card, or preferably a contactless-type smart card. The loyalty card stores the accumulated amount of money the shopper had spent in the store, and the associated loyalty points. It also optionally stores some of the recent transactions history.

Depending on the reward scheme, a shopper is entitled to a certain loyalty points for every certain amount of money spent in the store. When the shopper has completed a purchase, the entitled loyalty points will be added to his/her loyalty card, and optionally with the information of this purchase, such as the date, time, items and amount, through the Point-Of-Sale (POS) terminal at the cashier.

In any case, shoppers carry their own loyalty cards that store the loyalty points. Therefore, it is no longer necessary for retailers to keep the loyalty point records of their shoppers in centralized databases, and thus avoid the costly setup and maintenance costs.

Shoppers may at any time present their cards to any network terminals in the stores, and the network terminal will read the card, and instantaneously feedback the loyalty points balance of the shopper on the display, plus the list of the recent purchase history In addition, the relevant redeemable items the shopper is entitled to are also displayed. The shopper may thus interactively select some or all of these redeemable items through the touch-screen display, and present his/her card again to record these selected items for later redemption.

The network terminal may also enable personalized promotion by displaying personalized product and marketing messages to the shopper, which may easily grab the attention of the shopper.

Each network terminal may be a stand-alone unit or it may operate with or as part of a system. When the network terminal operates with or is part of a system, the network terminal is connected directly to the retailer's computer network, or optionally connected directly to the Internet, through the built-in Ethernet Network Adapter (100-base T standard), using TCP/IP as the communications protocol (TCP/IP stands for Transmission Control Protocol/Internet Protocol, and it is the standard communication protocol used in the Internet). Each network terminal is assigned an unique and valid IP address.

The computer at the retailer's head office remotely controls the operations of the network terminal through an optimized set of commands that the computer exchanges over a control/data interface with the network terminal. The commands are exchanged through the TCP/IP protocol, and the communication is done over the internet, or over the Public Service Telephone Network (PSTN) that connects the computer and the network terminal with LAN modems.

The control/data interface enables, for example, the retailers to modify and update the reward scheme of the loyalty program at any time, by sending the instructions from the sending computer to all the receiving network terminals. In the vice versa way, a similar control/data interface between the sending network terminal and the receiving computer enables the computer to collect the shoppers' information, such as the name, age, and shopping habits, when the shopper enters the information at the network terminal.

The network terminal also include a built-in Embedded Web Server. This enables the retailers to configure the network terminal easily with any standard Web Browser application, such as the well-known Microsoft Internet Explorer or Netscape Navigator. This embedded Web Server is one of the major breakthrough of the invention, and is specially developed from scratch, that is powerful enough to handle the setup, maintenance & daily operations, yet is small & cost-effective enough to fit into an embedded system.

Multiple network terminals may be connected together under the Master/Slave configuration. With this configuration, the retailer may only configure the reward scheme of the Master unit, and the reward scheme of all the associated Slave units will be automatically synchronized by the Master unit.

To enable the shopper to interact directly with a network terminal, the terminal includes a user interface and multiple data-entry devices. The shopper supplies the data to the network terminal through these data-entry devices, such as the smart card reader and the touch-screen panel. Once the network terminal reads a shopper's loyalty card with the smart card reader, the shopper then, through the user interface, specifies the redeemable items that he/she likes, and enters the selections through the touch-screen panel.

The System employs two strategies to recruit participants and to collect their personal information. First, whenever a new shopper makes the first purchase at the store, the shopper will be issued a new loyalty card in an ad-hoc manner, without asking the shopper to fill in all the tedious application forms And the shopper may immediately start to accumulate the loyalty points and enjoy the benefits of the loyalty program. On the other hand, other traditional methods often require the shopper to provide all the personal information in advance, such as the name, address, ID number, and age. These traditional approaches usually discourage people to participate since people are usually reluctant to provide the personal information. Therefore, the new approach effectively breaks the barrier of participation, and encourage shoppers to participate.

Second, when the shopper has accumulated enough loyalty points to redeem reward items, the network terminal will first determine if the shopper's personal information has already been collected or not. If not, the network terminal will ask the shopper to enter the required personal information through the network terminal's input device, which is usually through the touch-screen panel. The information may include the shopper's name, age, marital status, and the email address. Since the information is entered directly to the network terminal rather than filling in the application form, and since the shopper can see the immediate benefits (i.e. to redeem the reward items), the shopper is more willing to provide such information without all the concerns related to the traditional fill-in-the-form approach.

The system is suitable for small amount transactions. Unlike the traditional paper & sticker-based loyalty card systems, the new system uses smart cards to replace the paper cards as the loyalty cards, and the smart cards may store any kind of amounts, including dollars and cents. This makes it practical for the retailers that deal mostly with small amount transactions to implement the loyalty program.

As discussed in more detail below, the Retail Loyalty System may also be used as a data collection system for shoppers' personal information and buying habits, if the retailer wants to implement Customer Relationship Management (CRM) system on top of the loyalty system.

Every time when a shopper makes a purchase at the store, the associated loyalty points will be added to the shopper's loyalty card at the Point-of-Sales (POS) terminals at the cashier counter. This procedure is done by a special POS Add-in Module through an attached smart card reader/writer. This special module may 20 be a hardware module, or preferably be a software module that runs on the existing POS terminals.

At the same time when the POS Add-in Module adds the loyalty points to the shopper's loyalty card, the module also reads the information stored in the card, such as the shopper's personal information. The module will associate the shopper's information with the items that the shopper purchased. The new information may then optionally be stored in a memory buffer (an internal transaction log database) within the module. The information may immediately be sent to the centralized CRM database at the head office in real time via the Internet, or may be sent by batch through the PSTN once a day, preferably at the end of the day.

Similarly, the network terminal may also be used to collect information for the CRM purpose. The information may include the preference of the reward items for any particular group of shoppers.

Each loyalty card, whether it is contact-type or contactless-type smart card, can be divided internally into different number of memory blocks. The content of each of these blocks is encrypted and is protected by security keys, so each block may be read and write independently and securely. Therefore, a single loyalty card may be used by different affiliated companies. Each of these affiliated company may use one or multiple memory blocks assigned to this particular affiliated company, without affecting other memory blocks that are assigned to other affiliated companies. This provides effective cross-promotional tools between affiliated companies.

### BRIEF DESCRIPTION OF THE DRAWINGS

The above and further advantages of the invention may be better understood by referring to the following description in conjunction with the accompanying drawings, in which:

FIG. 1 is a block diagram of a typical setup of a retailer with two branches of retail stores according to the present invention;

FIG. 2 is a block diagram of a network terminal according to the present invention: and

FIG. 3 is a block diagram of the POS Add-in Module according to the present invention.

### DESCRIPTION OF THE PREFERRED EMBODIMENT

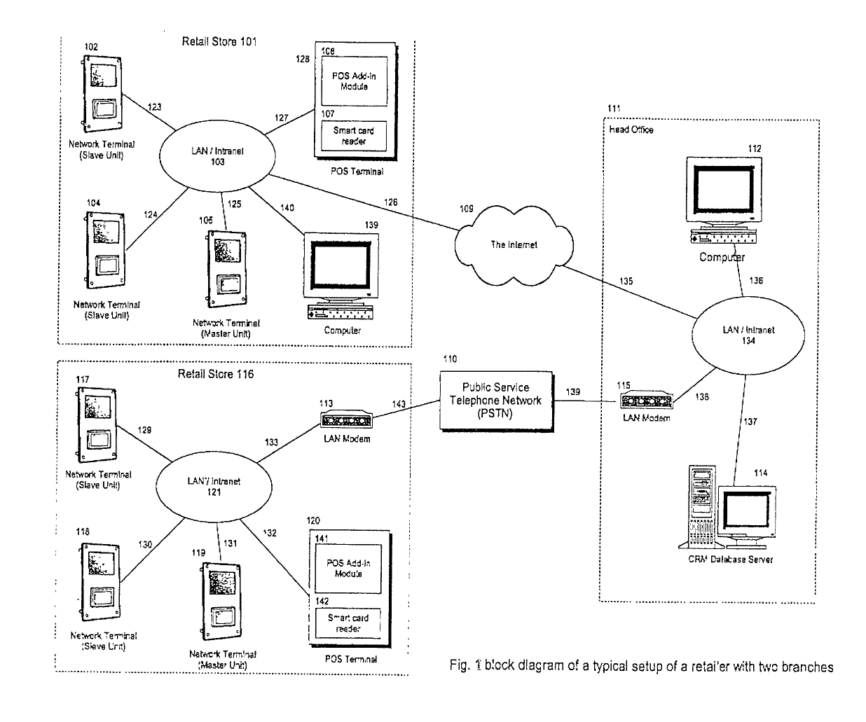

FIG. 1 is a block diagram of a typical setup of a retailer with two retail stores 101 & 116. Three network terminals are installed in the retail store 101 Network terminal 105 is configured as the Master Unit. Network terminals 102 & 104 are optional, and are configured as Slave units. The three terminals are mounted on the wall in the store 101, preferably in convenient places that are easily accessed by shoppers. Each network terminal has a 6.5″ touch-screen LCD display at the top half of the unit, and a contactless smart card reader module at the bottom half of the unit.

The network terminals are layered over the Local Area Network (LAN) 103. The connections among the network terminals 105′ 102 & 104 are established via standard Ethernet wiring 123, 124, & 125, using the well-known TCP/IP protocol.

There are also other devices connected to the LAN 103, including the Point-of-Sales (POS) terminal 128, and the optional computer 139, via the Ethernet connection 127 & 140 respectively, The LAN 103 is in turn connected to the Internet 109 via the Broad-Band Internet connection 126. This connection 126 can also be a dial-up connection, and in this case, additional dial-up modems (not shown) may be required.

The display contents (i.e., the reward scheme) are identical among the three network terminals 102, 104 & 105. To modify the reward scheme locally, one may use the computer 139 that runs the well-known Internet Browser program, such as the Netscape Navigator, to access and update the reward scheme of the Master unit 105. The Master Unit then synchronizes the reward scheme to the other slave units 102 & 104 automatically.

When a shopper purchases something in the store 101, he/she then presents the loyalty card to the cashier at POS terminal 128. The smart card reader module 107 of the POS terminal 128 reads the contents of the loyalty card, and passes the information to the POS Add-in Module 106 of the POS terminal 128. The POS Add-in Module 106 may be a hardware module, or preferably a software module that runs on top of the existing POS system. The module then checks the validity of the loyalty card, and to make sure this particular loyalty card belongs to this retail store. Depending on the amount spent in this purchase and the reward scheme, the module then calculates the entitled loyalty points, and notify the smart card reader module 107 to add the loyalty points to the loyalty card.

Optionally, the loyalty card may store the amount spent in this purchase, along with the date & time of the purchase, and along with the name or ID of the store. The loyalty card may also keep the accumulated amount of spending. The shopper can use this amount as an evidence of being a loyal shopper, and may get additional discount/service.

The shopper then presents the loyalty card to either one of the network terminals 102′ 104 & 105. The network terminal then reads the loyalty points from the loyalty card, and instantaneously display the loyalty points on the display. The network terminal then interactively display a list of the reward items redeemable by the accumulated loyalty points. In general, the more the loyalty points, the more the reward items will be shown.

The shopper then selects the reward items that he or she would like to redeem with the loyalty points by touching the item on touch-screen panel of the display. Multiple reward items may be selected. The shopper then present the loyalty card to the network terminal again, and his/her selections will be recorded to the loyalty card.

If this is the first time the shopper redeems the reward items with the loyalty card, the network terminal then asks for the shopper's personal information, including the age, sex, marital status, and the email address. The shopper enters the information via the touch-screen display. The network terminal then writes the information back to the loyalty card, and stores the information in the internal transaction log database.

To actually redeem the reward items, the shopper brings the loyalty card to the cashier at POS Terminal 128 (or other checkout counter not shown) again. The smart card reader 107 then reads the loyalty card and passes the information to the POS Add-in Module 106. The module then validates the loyalty card, and deduct the loyalty points accordingly. The Smart Card Reader Module 107 then updates the loyalty points of the loyalty card, and the shopper is then given the selected reward items.

Optionally, the POS Add-in Module 106 may record all the loyalty card transactions in the built-in transaction database module. The information may then be immediately sent to and updates the centralized database at the Centralized CRM (Customer Relationship Manager) Database Server 114 in the head office 111. The connection with the CRM Database Server 114 is established via the Internet broadband connection 126 & 135. Alternatively, when Internet Broadband connection is not available, the connection may be established via the Public Service Telephone Network (PSTN) 110. In this case, both sides may require a LAN Modem 113 and 115 to establish the connections 143 and 139, and the update procedure is preferably done by batch once or twice daily.

To periodically readjust the reward scheme, the Computer 112 in the Head Office 111 May be used to remotely synchronize the new reward scheme to all the network terminals in retail stores 101 & 116. This may be done by two approaches. First, the computer 112 may run the Internet Browser software to connect to each of the Master units in the stores, i.e., the Network Terminal 105 of the Retail Store 101, and the Network Terminal 119 of the Retail Store 116, and update the reward scheme contents one by one.

The preferred approach is to update all the network terminals together by running a special software module (not shown) in the Computer 112. Under this approach, the Master network terminal of each store is to be specified first. This may be done by specifying the IP address of the network terminal for the broadband connection situation (such as the Network Terminal 105), or by the telephone number for the PTN connection situation (such as the Network Terminal 119). Then the details of the new reward scheme, such as the pictures of the reward items, are entered into the Computer 112. After collecting all the required information, the Computer 112 will update all the Master network terminals accordingly and automatically, under the proprietary Retail Loyalty System (RLS) commands, which is briefly summarized in the following table:

| RLS Commands | Brief Description |
|---|---|
| RLS_INIT | To initialize the network terminal |
| RLS_CONNECT | To try to establish a connection between |
| | the computer 112 and one of the |
| | network terminals 105 & 119, by pass- |
| | ing the IP address or the telephone |
| | number of the network terminals to |
| | the command. |
| RLS_SET_STATUS | to set the status of the network terminal |
| RLS_GET_STATUS | To get the status of the network |
| | terminal |
| RLS_SET_AWARD | To pass a structure of a reward item, |
| | including the item name, the required |
| | royalty points to redeem, and the: |
| | picture of the item in jpeg |
| | format. |
| RLS_GET_AWARD | To get the existing reward items one |
| | by one from the network terminal. |
| RLS_SET_AWARD_COUNT | To set the total number of reward items |
| RLS_GET_AWARD_COUNT | To get the total number of the existing |
| | reward items of the network terminal. |
| RLS_SYNCTIME | To synchronize the system time of the |
| | network terminal with the computer |
| RLS_SET_IDLE_CONTENT | To set the display contents of the |
| | network terminal during the idle time |
| | (i.e., when no one is using the unit), |
| | such as advertisements and |
| | promotion messages. |
| RLS_GET_IDLE_CONTENT | To get the existing display contents |
| | for idle time. |
| RLS_GET_DEVICE_INFO | To get the information of the network |
| | terminal, such as the firmware version, |
| | total and free memory, and other status. |

The same set of RLS commands is used for the Master Network Terminal 105 to synchronize the reward scheme to the Slaves Network Terminals 102 & 104.

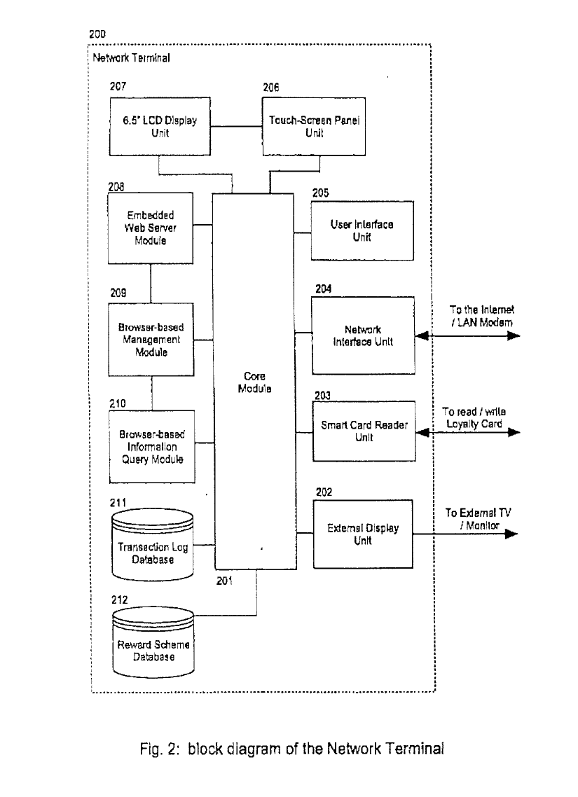

FIG. 2 is a block diagram of a network terminal 200. The main purpose of the network terminal 200 is to feedback the existing loyalty points to the shopper, and to provide a convenient way to allow the shopper to redeem reward items interactively.

In general, to check the loyalty points, the shopper presents the loyalty card to the network terminal 200, with the built-in Smart Card Reader Unit 203 located at the bottom half of the network terminal. The Smart Card Reader Unit then reads the loyalty card, and passes the contents of the card to the Core Module 201. The Core Module then displays the loyalty points through the Display Unit 207.

At the same time, the Core Module performs a look-up search, to retrieve the reward items stored in the Reward Items Database 212, that are redeemable by the loyalty points. The Core Module then displays all the redeemable reward items, and discards all the reward items that require more loyalty points than the loyalty card has. The shopper then selects the reward items that he or she would like to redeem. The shopper inputs his/her selections through the Touch-Screen Panel Unit 206, which then passes the information back to the Core Module 201.

The Core Module then reviews the contents of the loyalty card. If the shopper's personal information is not available in the loyalty card, the Core Module then asks the shopper to enter the personal information via the User Interface Unit 205 (displayed through the display unit 207). The shopper then enters the personal information via the Touch-Screen Panel Unit 206, including the Age, Gender, Number of Children, Martial Status, and the email address.

After the personal information is collected, the Core Module then updates the contents of the loyalty card, to include the personal information and the selected reward items. The network terminal then asks the shopper to present the loyalty card again, and it then writes the information back to the loyalty card via the Smart Card Reader Unit 203.

Optionally, the information is saved in the Transaction Log Database 211, for later on uploading to the CRM Database Server 114 in FIG. 1.

The network terminal 200 may be operated as a stand-alone unit or it may operate with or as part of a system. It may be connected directly to the computer network through the Network Interface Unit 204 by standard Ethernet wiring. At the initial setup, an unique and valid IP address is assigned to the network terminal, along with other related settings such as subnetmask & default gateway address. This may be accomplished by manually entering the IP address through the Touch-Screen Panel 206, or may be assigned by a DHCP server (not shown) if available. DHCP stands for Dynamic Host Configuration Protocol, which is a protocol that provides dynamic address allocation and automatic TCP/IP configuration.

An Internet Browser program is used to configure the network terminal and to setup the reward scheme. The Internet Browser (not shown) is a HTTP client. HTTP stands for Hypertext Transfer Protocol, which is the communications protocol used by all World-Wide-Web services to retrieve information The internet Browser sends requests to the Embedded Web Server Module 208, which receives and interprets the requests, and then notifies either the Browser-based Management Module 209 and Browser-based Information Query Module 210, depending on the particular requests. These two modules then send additional requests to the Core Module 201, which may retrieve information from the Transaction Log Database 211 and the Reward Items Database 212. The information is then passed back to the Embedded Web Server Module 208, for responding to the original HTTP requests, such as showing the information on the Internet Browser.

The Internet Browser may be run on any computer platform, such as Apple Matintosh, Unix machine, or PC running Microsoft Windows 95/98/2000/ME/XP, the Embedded Web Server Module 208 effectively enables platform-independent operations. Also, the Embedded Web Server Module allows any number of computers to simultaneously access the network terminal, and it eliminates the need for any dedicated computer to connect to and access the network terminal.

As an example, when the reward scheme is needed to be readjusted and updated, a connection is first established between the Internet Browser and the Network Terminal 200 through the Network Interface Unit 204. The Internet Browser then sends the requests to the Embedded Web Server Module 208 to update the reward scheme. The new reward scheme is then sent to the Browser-based Management Module 209, which then updates the Reward Items Database 212 via the Core Module 201. If the update is successful, the result then sends back to the Internet Browser through the Embedded Web Server Module 205 again, for displaying in the Internet Browser.

The Internet Browser may also be used to retrieve the transaction Log of the Network Terminal 200. The Browser-Based Information Query Module 210 is responsible for converting the raw data in the Transaction Log Database 211 into information that is meaningful to the users when shown in the Internet Browser. The transaction log usually includes the shopper's personal information, and the reward items that the shopper had redeemed.

During the idle time, the Network Terminal may show advertisements and promotional materials with the display unit 207. Alternatively, an external monitor, such as a big TV or Plasma Display, may be connected to the Network Terminal via the External Display Unit 202, to deliver the advertising materials to mass audience;

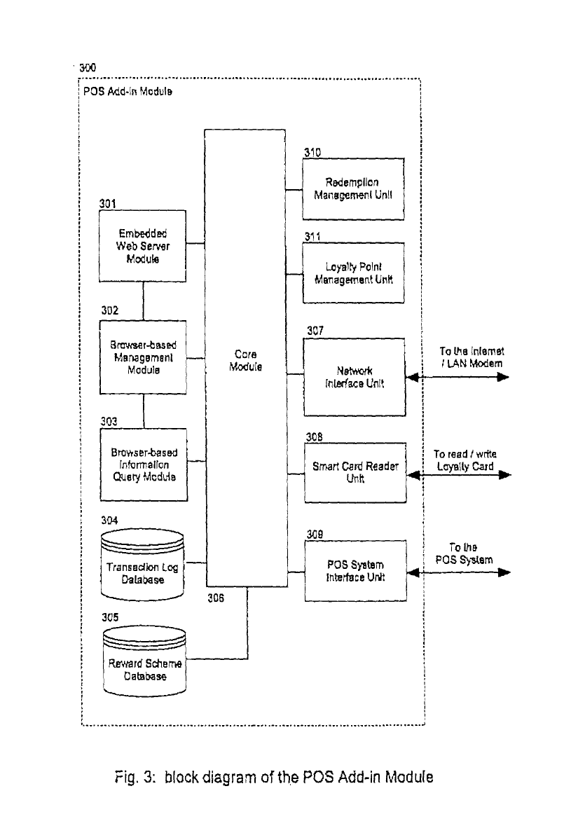

FIG. 3 is a block diagram of the POS Add-in Module 300. The main purpose of the POS Add-in Module is to enable the retailer to add the loyalty points of the shopper after making a purchase, and to deduct the loyalty points accordingly after redeeming the reward items.

The POS Add-in Module 300 may be implemented as a hardware unit physically attached to the existing POS system, or preferably be implemented as a software module that runs on top of the existing POS system.

After a shopper has made a purchase, the POS system then passes the information of this purchase to the POS Add-in Module 300, including the date & time, and the amount spent in this transaction, through the POS System Interface Unit 309. The POS System Interface Unit then passes the amount to the Core Module 306, which passes the information to the Loyalty Point Management Module 311. The Module then calculates the loyalty points earned by this amount, based on the information stored in the Reward Scheme Database 305.

The Loyalty Point Management Module then sends this earned loyalty points to the Smart Card Reader 308, and waits for the shopper to present his/her loyalty card for the update. Optionally, the transaction amount may be sent and updated to the loyalty card, along with the loyalty points.

Depending on the reward scheme, even a transaction with very small amount, such as a one-dollar-only transaction, may also earn loyalty points, since the loyalty card is a smart card, and is capable to storing any kind of amounts.

The Smart Card Reader Unit then returns the result to the Core Module 306, telling the Core Module if the update has been successful or not. The Core Module then passes this result back to the POS system via the POS System Interface Unit 309. Optionally, the transaction may be stared in the Transaction Log Database 304, for later on uploading to the CRM Database Server 114 in FIG. 1.

To redeem reward items, the shopper selects the items as discussed above in the Network Terminal. The shopper then brings the loyalty card to the POS terminal. The Smart Card Reader Unit 308 then reads the loyalty card and determines that the shopper is to redeem reward items, then it passes the contents to the Redemption Management Unit 310. The unit then performs a look-up search at the Reward Scheme Database 305, to determine the loyalty points required for the selected reward items, then passes the information back to the Smart Card Reader Unit 308 to deduct the loyalty points of the loyalty card accordingly.

Similar to the Network Terminal 200 discussed, the POS Add-in Module 300 may also be accessed by Internet Browser. The physical connection is established via the Network Interface Unit 307. The Embedded Web Server Module 301 is used to receive and interpret the requests, and may pass the requests to the Browser-based Management Module 302 and Browser-based Information Query Module 303 to serve the requests.

It will therefore be seen that we have developed a Retail Loyalty System, that is cost-effective, convenient, and user-friendly, for retailers to reward shoppers for their patronage and encourage repeat purchases. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed. For example, the Smart Card Reader Unit 203 in the Network Terminal 200 can read Magnetic Card or Contact-type Smart Card, rather then the Contactless-type Smart Card under the preferred embodiment.

Also, the Display Unit 207l is provided by a 6.5″ LCD display. However, alternatively other display devices, such as CRT monitor, can be used instead.

Furthermore, although the preferred embodiment uses the LAN modem 113 and 115 to establish the connection between the Network Terminal 119 at the Retail Store 116 and the Computer 112 at the Head Office 111, a normal dial-up modem, a wireless LAN device, or any other data interface device can be used.

In another embodiment, with moderate modifications, the same setup may be used as a pre-paid system. The Network Terminal 200 may be used to display the balance of the stored value in the pre-paid card, while the POS Add-in Module may be used to add and deduct the value of the card.

What is claimed is:

1. A first Retail Loyalty System Network Terminal, for shoppers to conveniently and interactively check the loyalty points and select the reward items, the first network terminal comprising:
a) a network interface for connecting directly to the computer network infrastructure establish a connection to the company network and/or to the Internet,
b) an Embedded Web Server that receives and responses to the requests sent from any Internet Browser having access to the computer network,
c) a browser-based management module that allows any Internet Browser that is capable of accessing the computer network to setup and maintain the network terminal,
d) a browser-based information query module that allows any Internet Browser that is capable to access the computer network to access the transaction log of the network terminal.

2. The network terminal defined in claim 1, wherein the Embedded Web Server enables different kind of computers, such as Apple Macintosh, Unix Machine, or PC running Microsoft Windows 95/98/2000//ME/XP, to connect to and to access the network terminal, and to setup, and maintain the reward scheme of the network terminal, through the standard Internet Browser, i.e., it enables platform-independent operations.

3. The network terminal defined in claim 1, wherein the Embedded Web Server allows any number of computers to simultaneously access the network terminal.

4. The network terminal defined in claim 1, wherein the Embedded Web Server enables remote computers to perform remote access from remote sites through standard Internet Browser.

5. The network terminal defined in claim 1, wherein the Embedded Web Server eliminates the needs for any dedicated computer to connect to and to access the network terminal.

6. The network terminal defined in claim 1, wherein the Browser-based management module includes the management software, that enables the Internet Browser to setup and maintain the network terminal and to readjust the reward scheme.

7. The network terminal defined in claim 1, wherein the Browser-based management module includes the management software, that eliminates the needs for any additional management software package to setup and maintain the network terminal and to readjust the reward scheme.

8. The network terminal defined in claim 1, wherein the Browser-based information query module includes the software to access the transaction log data base, that can dynamically generate real-time transaction log report from the transaction log records.

9. The network terminal defined in claim 1, wherein the Browser-based information query module allows users to access the transaction log through standard Internet Browser.

10. The network terminal defined in claim 1, that implements the proprietary RLS protocol, to allow the synchronization of the reward scheme between Master network terminal and Slave network terminal automatically without user interface.

11. The network terminal defined in claim 1, further comprising a Display Unit that shows the loyalty program-related information, such as the loyalty points, the accumulated amount spent in the store, the history of spending, and the reward items.

12. The network terminal defined in claim 11, wherein the Display Unit displays advertisements and promotional materials, in either still picture format or in movie format, during the idle time when no shopper is using the unit.

13. The network terminal defined in claim 11 wherein the Display Unit displays personalized product and marketing messages to the shopper for personalized promotion.

14. The network terminal defined in claim 1, further comprising a Touch-Screen Panel Unit, that acts as an input device to allow the shopper to interactively select the reward items.

15. The network terminal defined in claim 14, wherein the Touch-Screen Panel Unit allows the shopper to enter his/her personal information, such as age, martial status, email address, and so on.

16. The network terminal defined in claim 1, further comprising a Transaction Log Database that stores the transaction history that can be used for CRM (Customer Relation Management) purposes.

17. The network terminal defined in claim 1, further comprising a Reward Scheme Database, that enables the reward scheme to be changed and readjusted easily from time to time, to adapt for any product specific promotion, seasonal campaigns and time-sensitive promotion.

18. The network terminal defined in claim 1, further comprising a Smart Card Reader Unit that reads and writes the contents of the loyalty card (either contact-type or contactless-type smart card).

19. A first POS Add-in Module that works with any existing POS (Point of Sales) system, comprising:
a) network interface for connecting directly to the computer network infrastructure establish a connection to the company network and/or to the Internet,
b) an Embedded Web Server that receives and responses to the requests sent from any Internet Browser having access to the computer network,
c) a browser-based management module that allows any Internet Browser that is capable of accessing the computer network to setup and maintain the network terminal,
d) a browser-based information query module that allows any Internet Browser that is capable to access the computer network to access the transaction log of the network terminal.

20. The POS Add-in Module defined in claim 19, that implements the proprietary RLS protocol, to allow the synchronization of the reward scheme with the network terminal defined in claim 1.

21. The Add-in Module defined in claim 19, further comprising a POS system interface unit that sends and receives the loyalty program-related information, such as the transaction amount and loyalty points, with the POS system.

22. The POS Add-in Module defined in claim 19, further comprising a Transaction Log Database that stores the transaction history that can be used for CRM (Customer Relation Management) purposes.

23. The POS Add-in Module defined in claim 19, further comprising a Smart Card Reader Unit that enables the POS system to access the loyalty card (either contact-type smart card or contactless-type smart card), and to add and deduct the loyalty points of the loyalty cards.

24. The POS Add-in Module defined in claim 19, further comprising a Redemption Management Unit that determines the loyalty points required to redeem the reward items.

25. The POS Add-in Module defined in claim 24, wherein the Redemption Management Unit passes the loyalty points to the Smart Card Reader Unit for deducting the loyalty points of the loyalty card.

26. The POS Add-in Module defined in claim 19, further comprising a Loyalty Point Management Unit that determine the loyalty points earned by the purchase transaction.

27. The POS Add-in Module defined in claim 26, wherein the Loyalty Point Management Unit passes the earned loyalty points to the Smart Card Reader Unit for adding the loyalty points to the loyalty card.

28. A method of implementing a Retail Loyalty System that can effectively recruit participants, and to collect shoppers' personal information for CRM (Customer Relationship Management) purpose, a method comprising the steps of:
a) issuing a loyalty card (either a contact-type smart card or contactless-type smart card) to every new shopper at their first visit, without asking for personal information in advance;
b) the shopper may earn loyalty points even at their first visit to the store:
c) the shopper may remain anonymous until the first time he or she redeems reward items,
d) after selecting the reward items to redeem the first time via the Network Terminal defined in claim 11 the Network Terminal then asks for the personal information, such as age, sex, marital status, and number of children.
e) once the personal information is entered, it is then stored in the loyalty card, and can be retrieved at the next purchase.
f) the personal information of the shopper then can be associated with the purchased items for CRM purchases.

29. A method of implementing a Retail Loyalty System that can effectively create and sustain customer loyalty and repeat purchases, a method comprising the steps of:
a) enabling the shopper to earn loyalty points for all purchase transactions, even the transaction amount is minimal;
b) adding the loyalty points on-the-fly to the loyalty card (either contact-type or contactless-type smart card) in real-time manner without asking the shopper to fill in any form in advance;
c) allowing the shopper to check the loyalty points with real-time feedback conveniently by simply presenting the loyalty card to the Network Terminal defined in claim 1, without any need for store assistance;

30. A method of implementing a Retail Loyalty System that can reduce the setup and maintenance cost for the retailers, a method comprising the steps of:
a) avoiding the centralized database to store all the shoppers' transaction history and loyalty points, by storing the loyalty points in their own loyalty card;
b) avoiding the setup and maintenance of the customer hot line for the shoppers to check the loyalty points through the telephone, as the shoppers can check the loyalty points on their own at the store level and get real-time feedback by simply presenting the loyalty card to the Network Terminal defined in claim 1;
c) allowing periodically readjusting the reward scheme in web-speed conveniently via the Internet;

31. A method of implementing a Retail Loyalty System that can be used among affiliated retailers, a method comprising the steps of:
a) dividing the memory of the loyalty card (either contact-type or contactless type smart card) into a number of sub-blocks, and each sub-block is allocated to one of the affiliated retailers, and is protected by secret keys;
b) each one of the affiliated retailers reads and writes on their allocated sub-blocks of the loyalty card only, without affecting and altering the other sub-blocks that are not allocated to the retailer.
